(19) United States
(12) Patent Application Publication
(10) Pub. No.: US 2015/0302648 A1
(43) Pub. Date: Oct. 22, 2015

(54) SYSTEMS AND METHODS FOR MAPPING AN ENVIRONMENT USING STRUCTURED LIGHT

(71) Applicant: SULON TECHNOLOGIES INC., Markham (CA)

(72) Inventor: Jian ZHANG, Oakville (CA)

(21) Appl. No.: 14/625,448

(22) Filed: Feb. 18, 2015

Related U.S. Application Data
(60) Provisional application No. 61/941,040, filed on Feb. 18, 2014.

(51) Int. Cl. G06T 19/00; H04N 13/02; H04N 5/232; G02B 27/01

(52) U.S. Cl. CPC G06T 19/006; G02B 27/017; H04N 13/0271; H04N 5/23238

(57) ABSTRACT

A multi dynamic environment and location based active augmented reality (AR) system is described. Scanning and mapping are performed from the perspective of a user wearing a head mounted display (HMD) in the physical environment. Systems and methods are described herein for projecting structured light onto a physical environment and capturing reflections of the structured light to map the environment.

### TECHNICAL FIELD

The following generally relates to systems and methods for scanning and mapping an environment using structured light for augmented reality and virtual reality applications.

### BACKGROUND

The range of applications for augmented reality (AR) and virtual reality (VR) visualization has increased with the advent of wearable technologies and 3-dimensional (3D) rendering techniques. AR and VR exist on a continuum of mixed reality visualization.

### SUMMARY

In one aspect, a system for mapping a physical environment for augmented reality and virtual reality applications is provided, the system comprising: a scanning module having a field of view, the scanning module comprising: a projecting device for emitting a predetermined pattern of structured light into the physical environment, the structured light being emitted within the field of view, the structured light comprising a pattern which when projected onto a surface is reflected with distortions indicative of texture of the surface; and a capturing device for capturing reflections of the structured light in the field of view; and a processor in communication with the scanning module, the processor configured to: communicate, with the scanning module, the emitted pattern of structured light to be emitted; obtain the reflections from the capturing device; compare the reflections to the emitted pattern to determine distortions between the reflections and the emitted pattern; and generate a depth image for the physical environment within the field of view from the comparison.

In another aspect, a method for mapping a physical environment for augmented reality and virtual reality applications is provided, the method comprising: emitting, from a projecting device of a scanning module, a predetermined pattern of structured light into the physical environment, the structured light being emitted within a field of view, the structured light comprising a pattern which when projected onto a surface is reflected with distortions indicative of texture of the surface; capturing, at a capturing device of the scanning module, reflections of the structured light; obtaining the reflections from the capturing device; comparing the reflections to the emitted pattern to determine distortions between the reflections and the emitted pattern; and generating a depth image for the physical environment within the field of view from the comparison.

These and other aspects are contemplated and described herein. It will be appreciated that the foregoing summary sets out representative aspects of systems, methods, apparatus to assist skilled readers in understanding the following detailed description.

### DESCRIPTION OF THE DRAWINGS

A greater understanding of the embodiments will be had with reference to the Figures, in which:

FIG. 1 is a view of a head mounted display for use with a scanning system or method for mapping an environment;

FIG. 2 is an illustration of the components of a scanning system for mapping an environment;

FIG. 3 is an illustration of a 3D map of an environment;

FIG. 4 is a further illustration of the components of a scanning system for mapping an environment; and

FIG. 5 is a flowchart illustrating a method of scanning an environment.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure is directed to systems and methods for augmented reality (AR). However, the term “AR” as used herein may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following may refer to “AR” but is understood to include all of the foregoing and other variations recognized by the skilled reader.

Certain AR applications require mapping the physical environment in order to later model and render objects within the physical environment and/or render a virtual environment layered upon the physical environment. Achieving an accurate and robust mapping is, therefore, crucial to the accuracy and realism of the AR application.

One aspect involved in various mapping processes is scanning the environment using a scanning system. A scanning system may be provided on a head mounted display (HMD) worn by a user, and may be configured to scan the environment surrounding the HMD. The scanning system may provide scans of the environment to a processor for processing to generate a 3D depth map of the environment surrounding the user. The depth map of the environment may be further used in AR and VR applications.

A scanning system for mapping a physical environment for an AR application is provided herein. The scanning system comprises a projecting device and a capturing device. The projecting device is configured to emit structured light according to a predetermined geometric pattern. Once emitted, the structured light may reflect off of objects or walls in the environment. The capturing device is configured to capture the reflections of the structured light. Deviations present in the reflections of the structured light, as compared to the emitted light, may be processed by a processor to generate a depth image, wherein the depth image indicates the distance from the HMD to various points in the environment. Specifically, the depth image is generated for a section of the environment within the field of view of the scanning system.

The scanning system may be moved throughout the environment while emitting and capturing structured light (i.e. while scanning) in order to generate additional depth images of the environment. The depth images may be combined by the processor to provide a depth map of the environment.

In embodiments, the projecting device and the capturing device are calibrated together, so that the depth image accurately corresponds to the topography of an environment.

In embodiments, the HMD further comprises a camera system, wherein the camera system may provide an image stream to the HMD, optionally for displaying to a user. The camera system may be calibrated with the projecting device and capturing device to ensure that each region, such as a pixel, imaged by the camera system can be accurately mapped to depth information in depth images generated from the reflections captured by the capturing device.

In embodiments, the processor may provide the 3D map of the environment to a graphics engine operable to generate a rendered image stream comprising computer generated imagery (CGI) for the mapped physical environment to augment user interaction with, and perception of, the physical environment. The CGI may be provided to the user via an HMD as a rendered image stream or layer. The rendered image stream may be dynamic, i.e., it may vary from one instance to the next in accordance with changes in the physical environment and the user's interaction therewith. The rendered image stream may comprise characters, obstacles and other graphics suitable for, for example, “gamifying” the physical environment by displaying the physical environment as an AR.

The singular “processor” is used herein, but it will be appreciated that the processor may be distributed amongst the components occupying the physical environment, within the physical environment or in a server in network communication with a network accessible from the physical environment. For example, the processor may be distributed between one or more head mounted displays and a console located within the physical environment, or over the Internet via a network accessible from the physical environment.

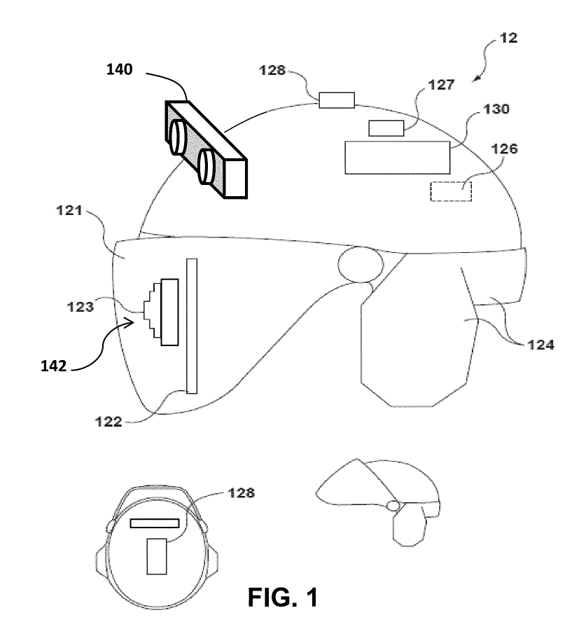

In embodiments, the scanning system may be mounted to an HMD for being removably worn by a user. Referring now to FIG. 1, an exemplary HMD 12 configured as a helmet is shown; however, other configurations are contemplated. The HMD 12 may comprise: a processor 130 in communication with one or more of the following components: (i) a scanning, local positioning and orientation module 128 comprising a scanning system 140 for scanning the physical environment, a local positioning system (“LPS”) for determining the HMD's 12 position within the physical environment, and an orientation detection system for detecting the orientation of the HMD 12 (such as an inertial measurement unit “IMU” 127); (ii) an imaging system, such as, for example, a camera system 142 comprising one or more cameras 123, to capture image streams of the physical environment; (iii) a display system 121 for displaying to a user of the HMD 12 the AR and the image stream of the physical environment; (iv) a power management system (not shown) for distributing power to the components; and (v) an audio system 124 with audio input and output to provide audio interaction. The processor 130 may further comprise a wireless communication system 126 having, for example, antennae, to communicate with other components in an AR system, such as, for example, other HMDs, a gaming console, a router, or at least one peripheral to enhance user engagement with the AR.

The processor 130 may carry out multiple functions, including rendering, imaging, mapping, positioning, and display. The processor may obtain the outputs from the LPS, the IMU and the scanning system to model the physical environment in a map (i.e., to map the physical environment) and generate a rendered image stream comprising computer generated imagery (“CGI”) with respect to the mapped physical environment. The processor may then transmit the rendered image stream to the display system of the HMD for display to user thereof. In conjunction with the processor 130, the scanning system is configured to scan and map the surrounding physical environment in 3D. The generated map may be stored locally in the HMD or remotely in a console or server. The processor may continuously update the map as the user's location and orientation within the physical environment changes. The map serves as the basis for AR rendering of the physical environment.

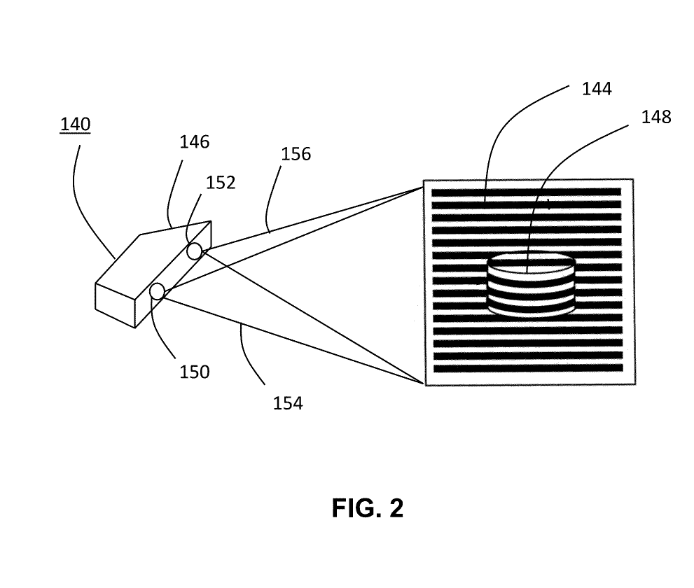

Referring now to FIG. 2, shown therein is a scanning system 140 for scanning a physical environment for use in AR and VR applications. The scanning system 140 comprises a projecting device 150 and a capturing device 152. The projecting device 150 and capturing device 152 may be mounted to a chassis 146 for retaining the components of the system 140 in a fixed, spaced apart relationship that may be recorded for use in calibrating the scanning system 140. In various embodiments, the scanning system 140 may further comprise or be communicatively linked to a camera system 142, and/or an IMU 127.

The projecting device 150 may be, for example, a laser emitter (whether operating within or outside of the visible light spectrum) or an infrared emitter configured to project patterned light into the physical environment. Alternatively, the structured-light projector may comprise a light source and a screen, such as a liquid crystal screen, through which the light source passes into the physical environment. The resulting light emitted into the physical environment will therefore be structured in accordance with a pattern, an example of which is shown by element 144. As shown by element 144, the structured-light projector may emit light as a pattern comprising a series of intermittent horizontal stripes, in which the black stripes represent intervals between subsequent projected bands of light. The structured-light projector may further emit light in other patterns, such as a checkerboard pattern. Alternative suitable approaches can also be used, provided the projection of such structured pattern onto a surface will result in distortions or deviations to the pattern from which texture can be derived.

The capturing device 154 may further comprise a camera operable to capture, within its field of view, reflections of the projected pattern, the reflections being reflected from the physical environment. The capturing device may be an infrared detector or photo detector for detecting light at the frequency range emitted by the projecting device 150.

In use, the projecting device 144 projects a pattern of structured light outwardly from the scanning system into an environment along its field of view 154. The structured light may then reflect off of objects within the environment. The capturing device 154 then captures the reflections of the structured light according to its field of view 156.

A processor, such as a processor on the HMD, is configured to determine topographies for the physical environment based on deviations between structures of the emitted and captured light. For an example of a cylinder 148, as shown in FIG. 2, a stripe pattern projected from the structured-light projector will deviate upon encountering the surface of the cylinder 148 in the physical environment. Essentially, horizontally emitted stripes are reflected back with a curvature, indicating the curvature of the incident surface of the cylinder. The capturing device 154 captures the reflected pattern from the cylinder and communicates the captured reflection to the processor. The captured reflection may be stored in memory. The processor may then map the topography of the cylinder by calculating the deviation between the cast and captured light structure, including, for example, deviations in stripe width (e.g., obstacles closer to the scanning system will reflect smaller stripes than objects lying further in the physical environment, and vice versa), shape and location. Structured-light scanning may enable the processor to simultaneously map, in 3 dimensions, a large number of points within the field of view of the capturing device, to a high-degree of precision. Accordingly, the processor may process the captured reflection to provide distance information correspondent to each region, such as a pixel, of the capturing device's view. The distance information can be processed by the processor to build a depth image of the area that has been illuminated by the projector, and whose reflections have been captured by the capturing device (i.e. scanned areas of the physical environment). The depth image may have a varying level of accuracy depending on characteristics of the projecting device, capturing device, processor and environment. For example, the resolution of the capturing device may affect the accuracy of the depth image.

In embodiments, while repeatedly scanning, the scanning system 140 is moved and rotated through the environment to generate additional depth images. The processor may be configured to process the depth images to generate a 3D map of the environment, including 3D depictions of objects and walls in the environment.

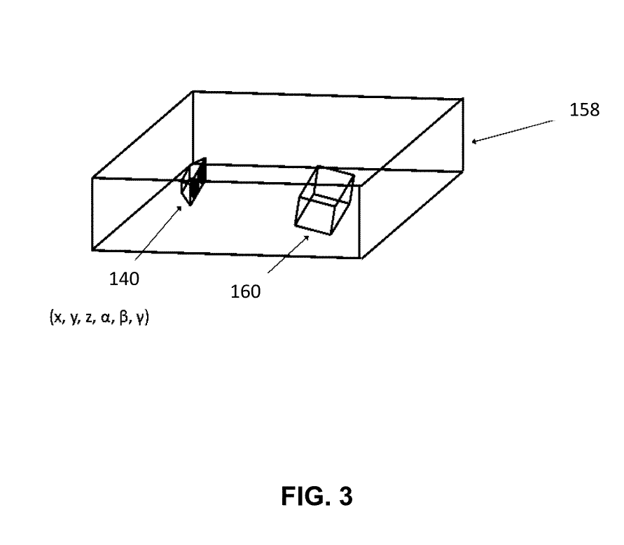

Referring now to FIG. 3, shown therein is an illustrative representation of a depth map generated by the processor. The depth map 158 of the room may additionally comprise a 3D representation of one or more object 160 present in the room.

As described above, a depth map 158 may be generated by the processor from a plurality of depth images taken by the scanning system as it moves through a physical environment while scanning. In use, the map can be initially generated by the scanning system be rotated in approximately a common (x, y, z) coordinate. Alternatively, the scanning system could be moving throughout the room during mapping, and the generated depth images could be transformed to approximate being captured from a common coordinate.

Stitching may be performed on the depth images in order to combine them, if the processor determines the relative position and orientation of the scanning system in the room when each image is taken. The processor may determine, from the depth map, the relative position and orientation of the scanning system, the position comprising x, y, z, α, β, γ coordinates.

In order to ensure that depth images (and the depth map) accurately reflect distances from the HMD to obstacles in the environment, the projecting device may have to be calibrated with the capturing device. Specifically, in order for the capturing device to accurately determine distances for the depth images and map, the capturing device and the projecting device must be calibrated by the processor such that any region, such as a pixel, imaged by the capturing device may be correctly mapped to a correct region of the emitted structured light pattern. Calibration software is readily available, such as described in the article Simple, Accurate, and Robust Projector-Camera Calibration by Daniel Moreno and Gabriel Taubin, Brown University, Providence, R.I., http://mesh.brown.edu/calibration/files/Simple,%20Accurate,%20and%20Robust%20 Projector-Camera%20Calibration.pdf, https://code.google.com/p/procamcalib/. Software is also available from the Projector-Camera Calibration Toolbox at https://code.google.com/p/procamcalib/.

Calibration of the projecting device and capturing device may project a pattern of structured light onto a surface and object, the surface and object having a known topography. The capturing device may be controlled to capture a reflection of the projected pattern, and the processor may generate a depth image from the captured reflection. The processor may determine transformations required to correctly match the depth image generated by the processor with the known topography.

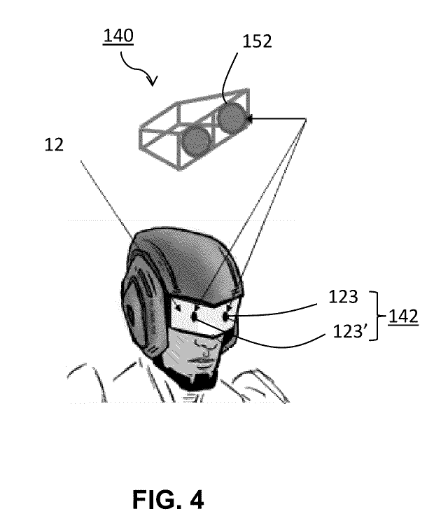

Referring now to FIG. 4, in various embodiments the scanning system is communicatively linked to a camera system 142 of the HMD, wherein the camera system 142 is configured to provide an image stream of the environment. The camera system 142 may comprise a single camera 123, or may comprise at least one additional camera 123′ in order to provide a stereoscopic image stream of the environment.

In embodiments, each camera 123 in the camera system 142 is calibrated with the scanning system 140. Each camera 123 in the camera system 142 may be calibrated with the capturing device 152 and the projecting device 150 to ensure the accurate correlation of the depth information in the depth images to the image streams of the cameras 123. More particularly, the processor may be configured to align the depth information from the depth image from the capturing device 152 with each physical image stream captured by the cameras 123, 123′ such that, for any region, such as a pixel, within the physical image stream of the cameras 123, 123′, the processor 130 may determine the corresponding position of the region in world coordinates relative to the image camera 123, 123′. The processor aligns the physical image stream with the depth information according to any suitable calibration technique.

Specifically, calibration may ensure that individual regions, such as pixels, in the image streams of each camera 123, 123′ may be accurately correlated to regions captured by the capturing device 152 (and associated depth images). Once calibrated, the depth information from a depth image provided for a certain point in the field of view of the capturing device 152 can be correctly correlated to a region, such as a pixel, in the image stream of either camera 123, 123′ in the camera system 142.

According to a particular technique of calibrating the cameras 123, 123′ with the projecting device 150 and capturing device 152, the processor applies a graphics technique, such as an image segmentation, to the images of the capturing device 152 and the cameras 123, 123′ and the processor determines a particular point in a world map common to the field of view of at least the capturing device 152, and the cameras 123, 123′. The processor may apply epipolar geometry to determine the same world coordinate in the field of view of the cameras 123, 123′. A transformation is then determined to align the view of the capturing device 152 with the cameras 123, 123′. Specifically, a transformation is determined such that a given region, such as a pixel, in the field of view of any of the devices can be correlated to a region in the field of view of the other devices. Calibrating the cameras 123, 123′ and the components of the scanning system may require processing of stored values relating to the relative position of each device on the HMD and the internal device specifications of each device—including field of view, number of pixels, and exposure settings.

Various embodiments of the display system 121 of the HMD are contemplated. Components of the display system may require further calibration with components of the scanning system 140 and the camera system 142.

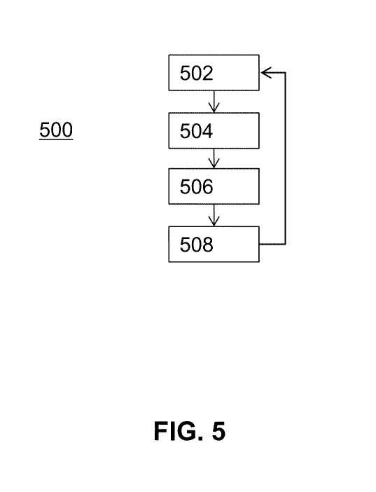

Referring now to FIG. 5, shown therein is a method of scanning an environment for providing a depth image thereof with a scanning system, as described in more detail above. At block 502, the projecting device 150 and capturing device 152 are calibrated by the processor. This step may be referred to as a “pre-calibration”. The pre-calibration of the projecting device and the capturing device ensures that a generated depth image accurately corresponds to the topography of the scanned portion of the environment. At block 503, if the scanning system comprises a camera system, an optional second calibration may be performed, wherein during the second calibration the camera system is calibrated by the processor with the components of the scanning system, in order to correlate the generated depth image with at least one image stream from the camera system. At block 504, the projecting device is actuated by instructions from the processor to output structured light according to a predetermined pattern. The structured light may be in the visible light range of the frequency spectrum, or may not be visible to incidental human observers. At block 506, the capturing device captures and stores reflections of the structured light. At block 508, the processor processes the captured reflections to generate a depth image of the current field of view of the capturing device. Specifically, the processor generates a depth image by measuring deviations between a predetermined pattern emitted by the projecting device, and reflections captured by the capturing device. Blocks 504 to 508 may then be repeated if it is desired that the scanning system continuously scans the environment, optionally as the scanning system is moved throughout the environment, providing additional depth images with each additional frame captured by the capturing device.

In embodiments, in order to generate a 3D map of the environment, the scanning system is preferably moved and rotated therethough, so that the processor can generate 3D depth images providing depth information for the objects in the environment. The processor is configured to construct a 3D map of the environment by combining multiple depth images.

The 3D map of the environment may be output or further processed by the processor for use in AR/VR applications. For example, the 3D map of the environment may be used to accurately place virtual objects in a room with realistic occlusion of virtual objects and real objects, such that a user wearing an HMD views a virtual environment that at least partly conforms to the physical environment surrounding them. Further, given a 3D map of the environment, virtual objects may placed and interacted with outside of the current field of view of the user. Optionally, the 3D map of the environment can be output for use in game engines such as Unity 3D™ or the Unreal™ game engine. These game engines can use the 3D map as the 3D environment instead of generating a 3D environment, which may save development time for some applications. The applications for the 3D map of the environment are not limited to gaming environments.

It will be understood that for some applications a partial 3D map may be sufficient, such that the scanning system may not need to be moved and rotated through the environment.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

We claim:

1. A system for mapping a physical environment for augmented reality and virtual reality applications, the system comprising
a) a scanning module having a field of view, the scanning module comprising:
i) a projecting device for emitting a predetermined pattern of structured light into the physical environment, the structured light being emitted within the field of view, the structured light comprising a pattern which when projected onto a surface is reflected with distortions indicative of texture of the surface;
ii) a capturing device for capturing reflections of the structured light in the field of view;
b) a processor in communication with the scanning module, the processor configured to:
i) communicate, with the scanning module, the emitted pattern of structured light to be emitted;
ii) obtain the reflections from the capturing device;
iii) compare the reflections to the emitted pattern to determine distortions between the reflections and the emitted pattern; and
iv) generate a depth image for the physical environment within the field of view from the comparison.

2. The system of claim 1, wherein the processor is further configured to generate additional depth images as scanning module has its field of view moved through the physical environment.

3. The system of claim 2, wherein the additional depth images are obtained by rotating the scanning module at approximately a common coordinate in the physical environment.

4. The system of claim 2, wherein the processor is further configured to generate a depth map of the physical environment corresponding to the depth image and additional depth images.

5. The system of claim 1, wherein the processor is configured to calibrate the capturing device with the projecting device.

6. The system of claim 1, the system further comprising a camera system comprising at least one camera, wherein the processor is further configured to calibrate the camera system with the scanning module.

7. The system of claim 1, the system further comprising an inertial measurement unit in communication with the processor, wherein the processor is further configured to obtain an orientation of the scanning module from the inertial measuring unit.

8. The system of claim 1, wherein the predetermined pattern comprises a plurality of horizontal stripes.

9. The system of claim 1, wherein the predetermined pattern comprises a checkerboard pattern.

10. A method for mapping a physical environment for augmented reality and virtual reality applications, the method comprising
a) emitting, from a projecting device of a scanning module, a predetermined pattern of structured light into the physical environment, the structured light being emitted within a field of view, the structured light comprising a pattern which when projected onto a surface is reflected with distortions indicative of texture of the surface;
b) capturing, at a capturing device of the scanning module, reflections of the structured light;
c) obtaining the reflections from the capturing device;
d) comparing the reflections to the emitted pattern to determine distortions between the reflections and the emitted pattern; and
e) generating a depth image for the physical environment within the field of view from the comparison.

11. The method of claim 10, further comprising generating additional depth images as the scanning module has its field of view moved through the physical environment.

12. The method of claim 11, wherein the additional depth images are obtained by rotating the scanning module at approximately a common coordinate in the physical environment.

13. The method of claim 11, further comprising generating a depth map of the physical environment corresponding to the depth image and additional depth images.

14. The method of claim 10, further comprising calibrating the capturing device with the projecting device.

15. The method of claim 10, further comprising calibrating a camera system comprising at least one camera with the scanning module.

16. The method of claim 10, further comprising obtaining an orientation of the scanning module from an inertial measuring unit.

17. The method of claim 10, wherein the predetermined pattern comprises a plurality of horizontal stripes.

18. The method of claim 10, wherein the predetermined pattern comprises a checkerboard pattern.
